(19) United States
(12) Patent Application Publication
(10) Pub. No.: US 2014/0279161 A1
(43) Pub. Date: Sep. 18, 2014

(54) ONLINE TRANSACTION TOOL

(71) Applicant: Auction.com, LLC, Irvine, CA (US)

(72) Inventor: Robert Friedman, Laguna Hills, CA (US)

(73) Assignee: Auction.com, LLC, Irvine, CA (US)

(21) Appl. No.: 14/214,671

(22) Filed: Mar. 15, 2014

Related U.S. Application Data
(60) Provisional application No. 61/852,056, filed on Mar. 15, 2013.

(51) Int. Cl. G06Q 30/08

(52) U.S. Cl. CPC G06Q 30/08
USPC 705/26.3

(57) ABSTRACT

A system for enabling and conducting an alternative transaction process for communicating price offers while conducting an online transaction in a networked environment is described. A transaction involving an item being offered for sale at a list price on an online medium is identified. Offers below the list price are received from potential buyers, but while the offers are below a minimum designated price, the seller is prompted to reduce the minimum designated price and is provided an interface for placing offers under an alias that pretend to outbid the previous bidders. When an offer is received that meets the minimum designated price, the alternate transaction process and the original transaction on the online medium are designated as complete based on the highest offer for the item.

### RELATED APPLICATION

This application claims the benefit of priority to Provisional Application No. 61/852,056, filed on Mar. 15, 2013, entitled ELECTRONIC TRANSACTION ONLINE TOOL; the aforementioned priority application being hereby incorporated by references in its entirety.

### TECHNICAL FIELD

Examples described herein pertain generally to online marketplaces, and more specifically to an online transaction tool.

### BACKGROUND

Numerous online marketplaces and other forums exist that enable consumers and sellers to transact for various kinds of items, such as collectibles, electronics and other goods or services.

However, not all of these forums are configured to provide potential buyers with an interface to make offers at less than a list price or configured to provide sellers with tools to manage these offers.

### BRIEF DESCRIPTION OF THE DRAWINGS

FIG. 1 illustrates an example system for enabling and conducting an alternative transaction process for communicating price offers while conducting an online transaction in a networked environment.

FIG. 2A illustrates an example method for conducting an alternative transaction process for communicating price offers while conducting an online transaction in a networked environment.

FIG. 2B illustrates an example method for enabling an alternative transaction process for communicating price offers while conducting an online transaction in a networked environment.

FIG. 3 illustrates a sample item for sale on an online medium associated with a displayed list price and an undisclosed minimum designated price.

FIG. 4 is a block diagram that illustrates a computer system upon which embodiments described herein may be implemented.

### DETAILED DESCRIPTION

Examples described herein include a system for enabling and conducting an alternative transaction process for communicating price offers while conducting an online transaction in a networked environment. Some embodiments are implemented in the context of an item listed for sale on an online medium, such as a community-based classifieds listing website or message forum. After or coincident with the item being listed online, one or more processes may be initiated to receive a trigger event and information related to the item in order to implement an alternative transaction process. In one example, this event is created by the user who originally listed the item for sale on the online medium. In other examples, the event may originate from the online medium, a potential buyer for the item, or be programmatically controlled by the system itself. Upon receiving this event, the system may then conduct the alternative transaction process.

According to some embodiments, a transaction for an item at an online listing source (e.g., Craigslist, a bulletin board, newsgroup, etc.) is identified. In an example, the item has an associated list price which represents an amount the seller is asking for the item on the online listing source. Continuing the example, the item also has an associated minimum designated price which represents the lowest offer the seller of the item would be willing to accept (i.e., a reserve price). This minimum designated price is not disclosed to other users of the online medium so they do not know the lowest price the seller will accept. In one embodiment, the minimum designated price is chosen by the seller, either at the time the seller places the listing or any time afterwards. Alternatively, the minimum designated price can be programmatically determined by the system, for example by referencing similar items sold in the past.

In an example, the system monitors for offers for the item during a designated period of time, such as a bidding period chosen by the seller. One or more offers for the item may be detected from a number of bidders during this time, one of which is identified as the highest offer.

In one example, the offers received for the item are hidden from users of the online medium. In further examples, the offers may also be hidden from bidders in the system, or the offers may be displayed to bidders or even to the users of the online medium.

In an embodiment, the system described may be implemented externally to the online listing source. For example, the online listing source may be a website hosted on one server, whereas the system described resides on a separate server. Alternatively, the system may be conducted through other means, such as an application on a computing device or a plug-in for another program (e.g., a web browser). In other embodiments, the system may be internal and implemented by the online listing source itself as an added service to users.

When a highest offer is identified during the period of time, the highest offer is compared to the minimum designated price for the item. In one embodiment, when the highest offer meets or exceeds the minimum designated price, the transaction is designated as complete in the system, at which point the seller may be obligated to sell the item to the bidder for the offered amount. In one embodiment, the system may also communicate that the transaction is complete to the online listing source where the item was originally listed for sale.

When none of the offers identified during the period of time meet or exceed the minimum designated price, the seller may be prompted to reduce the minimum designated price in order to complete a sale. In one example, the seller may also be provided an interface to place offers that compete with the bidders' offers in order to generate demand and raise the bidding price of the item. In an embodiment, these offers are disguised under aliases so that they appear to be placed by a legitimate user and not the seller. Through this method, bidders may believe there is more competition for the item than actually exists, leading to a higher offered price and increased likelihood of bidding eventually meeting the minimum designated price.

The term a “user” (or variants thereof) can refer to a buyer, a seller, or other individuals who can access a forum for listing items for sale using a computing device.

According to some examples, the system enables sellers of items on online marketplaces and forums to accept and manage offers to buy those items at less than their listed prices in a manner that is superior to doing so manually (e.g., through e-mail, telephone, or messaging services). Although a seller may not receive the listed price for an item, the system creates the possibility of receiving at least an amount meeting the seller's minimum desired sale price. Potential buyers also benefit from communication convenience and therefore may be more willing to place offers to buy than they would if their only choice was to do so manually. In addition, the system may enable sellers to surreptitiously compete with potential buyers by displaying fake offers made by the seller under an alias to the potential buyers. This prevents the impression that the seller is willing to negotiate on price, which may show weakness on the seller's part, and thus allows sellers to receive higher offers for their goods or services than otherwise possible.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs.

Auction Architecture

FIG. 1 illustrates an example system that provides an online tool for enabling an alternative transaction process for communicating price offers in a networked environment as between a buyer and a seller. A system 100 such as described by an example of FIG. 1 can be implemented in a variety of computing environments. For example, system 100 can be implemented as part of an online market system or environment, such as an online auction, or it can be implemented as a network service that augments or facilitates an online marketplace. In other examples, the system may be implemented through other means, such as an application on a computing device or a plug-in for another program (e.g., a web browser). Accordingly, system 100 can be implemented as a network service, through a combination of servers and/or other network-enabled computing devices. In variations, system 100 can be implemented on other computing platforms, including stand-alone systems. Thus, in some variations, system 100 can operate on a product or service that is maintained on a single computing or storage device.

In implementation, a seller can create a listing with an online marketplace. Subsequent to the listing, the system 100 can be triggered by, for example, the seller and/or one or more prospective buyers, in order to complete a transaction that results in the transaction price being different than the listing price. In this regard, system 100 provides an alternative process for a seller and prospective buyers to engage in a transaction, where the default process is a simple listing of the product or service for sale. By way of example, the seller may encounter prospective purchasers who do not wish to pay the listed price, and the seller may engage the system 100 as a tool to enable negotiations to a lower price.

In an example of FIG. 1, the components of system 100 can combine to enable and conduct an alternative transaction process for communicating price offers. In one example, system 100 includes a seller interface component 130, an alias component 135, a transaction component 150, a buyer interface component 160, and a transaction forum interface 170. System 100 can also interact with one or more online listing sources 122 which contain stores of sale item records 120.

As shown by an example of FIG. 1, a seller places an item on sale by advertising the item on an online listing source 122. The item can refer to any kind of merchandise, product, or service. For example, the item may be a vehicle, an antique, real estate property, etc. Types of real estate property can include a house, a townhouse, a condo, an apartment, a business property, land, etc. The online listing source 122 can refer to any online medium where users post items for sale, such as a community classifieds site (e.g., Craigslist), a message board, bulletin board service, newsgroup, auction site, etc. For example, a seller may place a couch on a message board for secondhand furniture sales in hopes of getting rid of the old couch for money. The couch will then have an associated sale item record 120 identifying key details of the item, which may vary depending on the format of the online listing source 122. For example, sale item record 120 can be an entry in a relational database, XML, or simply a prose description entered by the seller or generated by the online listing source 122. The details of the item contained in sale item record 120 may include a list price 112, descriptive features of the item such as size, weight, dimensions, color, etc., and information for a buyer about how to purchase the item through the online product listing source 122, in one embodiment.

In an example of FIG. 1, transaction forum interface 170 receives a record 115 based on the sale item record 120 from the online listing source 122. The record 115 can, for example, correspond to a structured data item, document, or clipped web page. The record may contain similar information to the sale item record 120, such as the list price 112. Transaction forum interface 170, parses record 115 to extract and order relevant data that the seller provided to the online listing source 122. In one example, transaction forum interface 170 pulls record 115 from the online listing source 122, such as through HTML, RSS, XML, or another protocol. Alternatively, the online listing source 122 may provide transaction forum interface 170 with record 115 either automatically or through user request. In a further example, the seller may directly provide transaction forum interface 170 with record 115, such as by manually inputting data or copying from the sale item record 120. Still further, in some variations, the user (e.g., seller) can input the information manually, without parsing the information.

In one embodiment, after parsing the record 115, transaction forum interface 170 can provide the parsed data, including list price 112, to transaction component 150. The transaction component 150 can communicate with the components of the system, including seller interface component 130 and buyer interface component 160 to enable the communication of price offers between buyers and the seller. The communication of price offers can optionally be performed discreetly—i.e., so that the offer is not published to other potential buyers. Seller interface component 130 and buyer interface component 160 may be provided, for example, as web pages. In an example, the buyer's offers and seller's interactions (e.g., setting the minimum designated price 140 and generating alias offers 114) are made on a single web page. In another example, these components may be implemented in an application, such as for a mobile device, or a plug-in for an application such as a web browser. In a further example, components may be provided as part of the online listing source 122.

In one variation, the seller accesses seller interface component 130 and designates a minimum designated price 140 for the item. The minimum designated price 140 represents the lowest offer the seller is willing to accept for the item (i.e., a reserve price) and is below the displayed list price 112 for the item on the online listing source 122. As a system 100 can be initiated after the product is listed in the online market, the published price can be copied over from the record 115. The seller can then specify a lower price that is not disclose to the prospective buyers. The minimum designated price 140 can be managed by transaction component 150, but may remain undisclosed to potential buyers through either the buyer interface component 160 or the online listing source 122.

Some embodiments provide for system 100 to implement the alternative process once seller and prospective buyers are identified and in agreement to use the alternative process. For example, a seller may respond to receiving an offer that is below the listed asking price for a particular item by sending a communication to the prospective buyer or buyers which invites them to engage an online tool provided by system 100. In a variation, the seller can initiate the alternative process at his own initiative, such as when no suitable offers are received for a listing. The implementation of the alternative process through system 100 can be known to the prospective buyers, or alternatively hidden from prospective buyers. Still further, the alternative process can be triggered programmatically by an event, such as (i) the seller receiving an offer for a listed item that is below the published price or the seller's pre-determined trigger price (or designated minimum price), and/or (ii) passage of time when seller receives of offers or no qualifying offers (e.g., above designated minimum price).

A prospective buyer can make a first offer 113 through buyer interface component 160. The offer 113 is received by transaction component 150 and provided to the seller via seller interface component 130.

In one example, if the value of the first offer 113 exceeds the minimum designated price 140, then the seller may accept the buyer's first offer 113 through transaction component 150. In one implementation, the transaction component 150 at least partially enforces the transaction once the prospective buyer submits a bid that exceeds the minimum designated price 140. For example, the transaction component 150 may cause publication of a message to both buyer and seller that “the offer has been accepted” when the buyer's offer exceeds the minimum designated price. Such a communication may be generated and communicated to the buyer without input from the seller, thereby precluding the seller from raising the price. Alternatively, the item may remain open to offers for a specified duration of time, at the end of which the buyer with the highest offer 113 which meets or exceeds the minimum designated price 140 is the transaction winter. This duration of time may be chosen by the seller or fixed by transaction component 150.

If the buyer's first offer 113 is below the minimum designated price 140, then the seller may access seller interface component 130 to choose between (i) ignoring the buyer's first offer 113, (ii) accepting the buyer's first offer 113, or (iii) reducing the minimum designated price 140 to an amount which is lower than the former previous minimum designated price 140. The seller's choice to reduce causes transaction component 150 to update the minimum designated price 140, although potential buyers are not informed of this change, in one embodiment.

Whether the seller chooses to reduce the minimum designated price 140 or not, the seller also has the choice to place an alias offer 114. More specifically, the system 100 may enable alias offers 114 that are functionally equivalent to offers 113 which would normally be received from potential buyers, except that alias offers 114 are placed by or on behalf of the seller, not the prospective buyers. The seller can access seller interface component 130 and direct alias component 135 to place an alias offer 114 on the seller's behalf. Alternatively, alias component 135 can be programmed, either by default or customized by the seller, to place alias offers 114 in response to buyer offers 113, at fixed intervals, or through other triggers.

In one implementation, the alias component 135 can create a virtual persona and associate the alias offer 114 with the virtual persona. This virtual persona may appear to generate from a person, so as to provide the appearance that the persona is another bidder. In other variations, transaction component 150 simply informs the buyer that a higher offer has been made for the item without disclosing any other details.

In some embodiments, the generation of a alias offer 114 can also coincide with reduction of the minimum designated price provided by the seller. In one implementation, when the seller submits the alias offer 114, the minimum reserve prices automatically reduced by a predetermined increment. In this way, the seller is guided towards a transaction prices more likely to be met.

In one example, alias offer 114 appears as a genuine second offer that exceeds the first offer 113 placed by a potential buyer. In some embodiments, the value of the alias offer 114 is hidden from the buyer and only the fact that a second offer has been received is communicated by transaction component 150. In variations, the alias offer 114 can be published or communicated to the other buyers. For example, all offers for the particular item can be published via the buyer interface component 160 of each prospective buyer.

When the alias offer is indicated to the prospective buyer, that buyer may then choose to make a third offer 113 to outbid the second offer. The second offer does not identify if the seller has reduced the minimum designated price 140, or whether the seller has caused the second offer to appear. As a result, the buyer may believe the alias offer 114 is a legitimate offer and may offer more for the item than originally intended. As such, use of the transaction component 150 enables a seller to appear as another buyer rather than a seller making a counteroffer. For example, from the perspective of a buyer 170, the seller may appear as another buyer.

Moreover, use of transaction component 150 enables the seller to make an offer in response to the buyer's first offer 113 without the stigma of being viewed as a seller that is willing to negotiate the final transaction price. Examples recognize that prospective buyers can on occasion interpret the negotiation of price as a sign of weakness. Instead, an example of FIG. 1 provides that the buyer is made aware of a second offer without being informed that the second offer originated from the seller. In some implementations, the prospective buyer is also without knowledge that the minimum designated price 140 has been reduced.

In an embodiment, the minimum designated price 140 is kept hidden from potential buyers by transaction component 150. As such, potential buyers make offers without knowing what minimum value the seller would accept.

In an example of FIG. 1, a sale item record 120 describes a bicycle for sale for $100 (list price 112) on an online listing source 122. Transaction forum interface 170 parses the record 115 and sends the formatted data, including list price 112, to transaction component 150. The seller accesses seller interface component 130 and designates a minimum designated price 140 of $80, which is hidden from buyers by transaction component 150. This minimum designated price 140 is also below the list price 112. An interested buyer makes a first offer 113 of $50 for the bicycle through buyer interface 160, which is below the minimum designated price of $80. The transaction component 150 provides the buyer's first offer 113 for $50 to the seller through seller interface 130 and provides the seller with a choice of (i) ignoring the buyer's first offer 113, (ii) accepting the buyer's first offer 113, (iii) reducing the minimum designated price 140 to a value less than the previous minimum designated price 140, but above the buyer's first offer 113, and/or (iv) placing an alias offer 114 to prompt the buyer to place a higher offer 113.

In the example, the seller chooses (iii) and reduces the minimum designated price 140 to $70. The seller also chooses to place an alias offer 114 through alias component 135. Transaction component 150 communicates to the buyer that a second offer has been made without identifying that the second offer is an alias offer 114. In addition, the transaction component 150 updates the minimum designated price to the reduced value of $70 without revealing this information to the buyer. The buyer makes a third offer 113 of $75 to compete with the second offer created by alias component 135. This value is greater than the minimum designated price 140, and the seller may be obligated to accept this offer 113 in some embodiments.

Methodology

FIG. 2A illustrates an example method for conducting an alternative transaction process for communicating price offers while conducting an online transaction in a networked environment. While operations of the method 200 are described below as being performed by specific components, modules or systems of the computer system 100, it will be appreciated that these operations need not necessarily be performed by the specific components identified, and could be performed by a variety of components and modules, potentially distributed over a number of machines. Accordingly, references may be made to elements of system 100 for the purpose of illustrating suitable components or elements for performing a step or sub step being described. Alternatively, at least certain ones of the variety of components and modules described in system 100 can be arranged within a single hardware, software, or firmware component. It will also be appreciated that some of the steps of this method may be performed in parallel or in a different order than illustrated.

With reference to an example of FIG. 2A, an item for sale at an online listing source 122 is identified through, for example, a transaction forum interface 170 in a system 100 as described with FIG. 1 (204). The online listing source 122 can refer to any online medium where users post items for sale, such as a community classifieds site (e.g., Craigslist), a message board, bulletin board service, newsgroup, auction site, etc. This item identified for sale also has an associated list price 112 at the online listing source 122 which is parsed by the transaction forum interface 170 and sent to transaction component 150 (205). In addition, in one embodiment, the seller of the item uses seller interface component 130 to choose a minimum designated price 140 representing the lowest offer the seller is willing to accept for the item (206). Alternatively, a minimum designated price 140 may be programmatically determined by, for example, transaction component 150 using historical data for similar items.

Once the item has been identified, transaction component 150 monitors for offers 113 received by potential buyers for the item through a buyer interface component 160 (207). For example, the item may be a bicycle with a list price 112 of $100, and a buyer may submit an offer 113 of $70. According to some implementations, once transaction component 150 detects the offer 113 for the item (208), the received offer 113 is compared to the minimum designated price 140. If transaction component 150 determines that the offer 113 meets or exceeds the minimum designated price 140 (212), transaction component 150 may designate the transaction as complete (224). In some embodiments, transaction component 150 can wait a specified duration of time for more offers. This duration may be chosen by the seller or be a system default setting. If no higher offer is received, in one example, the first offer 113 meeting or exceeding the minimum designated price 140 closes offers on the item (225). Otherwise, if a higher offer 113 is received during the duration, the highest offer is instead chosen over the first offer (226).

In one example, the transaction being designated as complete includes displaying through the transaction component 150 an indication that no more offers are being accepted for the item, or that the prospective buyer's offer has been accepted. This indication may include a message, icon, or other means informing potential buyers that the item is no longer available. In addition, any functionality provided by buyer interface component 160 to place offers for items can be disabled for completed transactions. In a further example, transaction component 150 may monitor the buyer and seller over a period of time to determine whether the item and appropriate compensation were exchanged successfully and then mark the transaction as final if so. If a problem occurred with the transaction, transaction component 150 may open the item back up to further offers 113.

If a first offer 113 or no offers within the specified duration of time meet or exceed the minimum reserve price 140, transaction component 150 can prompt or otherwise enable the seller to reduce the minimum designated price 140 to increase the likelihood of making a sale (216). In one embodiment, transaction component 150 waits for the seller selection and new minimum designed price 140 if the seller chooses to lower it (217). Alternatively, transaction component 150 may programmatically reduce the minimum reserve price 140 based on, for example, the seller's instructions, previous item history, offers received, etc. (218).

In some implementations, whether the minimum reserve price 140 is lowered or not, the seller can be provided an interface to place alias offers 114 (220). Alias offers 114 may be functionally equivalent from offers 113 from potential buyers, except that alias offers 114 are placed by or on behalf of the seller, not potential buyers. Instead, the seller can access seller interface component 130 and direct alias component 135 to place an alias offer 114 on the seller's behalf. Alternatively, alias component 135 can be programmed, either by default or customized by the seller, to place alias offers 114 in response to buyer offers 113, at fixed intervals, or through other triggers. The system 100 may permit the seller offer 114 only if the prospective buyer or buyers have failed to provide an offer that exceeds the minimum designated price. While some implementations provide for publishing or communicating the seller offer 114, the origin of the seller offer is not communicated to other prospective buyers.

Accordingly, after reducing the minimum designated price 140 for the item and/or placing an alias offer 114, transaction component 150 continues to monitor for new offers 113 (207). If no offers 113 meet the minimum designated price 140 after a certain period of time, transaction component 150 removes the item and stops accepting offers. Additionally, the seller can also choose to remove the item upon, for example, a buyer paying the list price 112 for the item on the online listing source 122.

FIG. 2B illustrates an example method for enabling an alternative transaction process for communicating price offers while conducting an online transaction in a networked environment. While operations of the method 250 are described below as being performed by specific components, modules or systems of the computer system 100, it will be appreciated that these operations need not necessarily be performed by the specific components identified, and could be performed by a variety of components and modules, potentially distributed over a number of machines. Accordingly, references may be made to elements of system 100 for the purpose of illustrating suitable components or elements for performing a step or sub step being described. Alternatively, at least certain ones of the variety of components and modules described in system 100 can be arranged within a single hardware, software, or firmware component. It will also be appreciated that some of the steps of this method may be performed in parallel or in a different order than illustrated.

With reference to an example of FIG. 2B, a user first chooses to sell an item through an online resource (e.g., Craigslist). The item can be published as an online listing source 122 of FIG. 1 (254). The item can refer to any kind of merchandise, product, or service. For example, the item may be a vehicle, an antique, real estate property, etc.

The forum transaction interface 170 receives a trigger and related information to implement an alternative transaction process (258). The trigger can, for example, be received from the seller selecting to use an online tool provided through system 100. Alternative, the trigger can be provided by both buyer and seller. Still further, the trigger for initiating the online tool can be generated through a programmatic mechanism. For example, in one implementation, the online tool of system 100 can be initiated automatically after X time period when listing receives no acceptable offer, or when detected activity/interest for the listing is below a defined threshold. For example, the number of persons who view the ad listing can be measured, and if the number of views is below a threshold, the system 100 may be automatically initiated or made available.

In reference to FIG. 1, one implementation provides that transaction forum interface 170 receives information (i.e., record 115) based on the sale item record 120 from the online listing source 122. The record 115 can contain similar information to the sale item record 120, such as the list price 112. Transaction forum interface 170 operates to parse record 115 to extract and order relevant data that the seller provided to the online listing source 122. In one example, transaction forum interface 170 is programmed to pull record 115 from the online listing source 122, such as through HTML, RSS, XML, or another protocol (259). Alternatively, the online listing source 122 may provide transaction forum interface 170 with record 115 either automatically or through user request. In a further example, the seller may directly provide transaction forum interface 170 with record 115, such as by manually inputting data or copying from the sale item record 120 (260). Still further, the seller can manually input some or all of the information from the listing.

After processing record 115, transaction forum interface 170 passes necessary information, such as the list price 112, to transaction component 150. In one embodiment, transaction component 150 then implements the alternative transaction process, such as through method 200 illustrated by example in FIG. 2A (262).

In one example, after the alternative transaction process has been successfully completed (e.g., a buyer makes an offer 113 meeting the minimum designated price 140 and the seller sends the buyer the item), transaction forum interface 170 can be instructed by transaction component 150 to mark the transaction complete at the online listing source 122 (266). In one embodiment, transaction forum interface 170 accesses and updates sale item record 120 through an application programming interface (API) running on online listing source 122. Alternatively, transaction forum interface 170 can communicate the update through e-mail or other methods.

### Example

FIG. 3 illustrates a sample item for sale listing 300 on an online medium (e.g., online listing source 122) associated with a displayed list price 112 and an undisclosed minimum designated price 140. In the example provided, a seller has listed a bicycle for sale with a list price 112 of $100 on the online listing source 122. The seller has also provided information such as a description and a picture to give potential buyers an idea of what they are looking at. All of this information (except the minimum designated price 140) makes up the sale item record 120 for this example.

A subset of this sale item record 120 information is contained in record 115, which is parsed by transaction forum interface 170 to extract and format the information, such as list price 112, for use by transaction component 150. Transaction component 150, in this example, can subsequently implement the alternative transaction process for communicating price offers, which will enable the seller to receive offers 113 for the bicycle at below the list price. The seller also inputs a minimum designated price 140 to the transaction component 150 using seller interface component 130 so that no offers 113 below that price will be accepted as completing the transaction by transaction component 150. In this example, the seller has chosen $80 as the initial minimum designated price 140. However, this $80 value is not part of the listing nor is it disclosed to potential buyers in this example.

In the example provided, the buyer can choose to purchase the item for the list price using the feature 310. Alternatively, the buyer can choose to make an offer 312. In one implementation, system 100 is triggered when the prospective buyer makes an offer. If the offer is less than the minimum designated price 140, the seller can choose to lower the minimum designated price and/or generate the alias offer.

Computer System

FIG. 4 is a block diagram that illustrates a computer system upon which embodiments described herein may be implemented. For example, in the context of FIG. 1, system 100 may be implemented using one or more servers such as described by FIG. 4.

In an embodiment, computer system 400 includes processor 404, memory 406 (including non-transitory memory), storage device 410, and communication interface 418. Computer system 400 includes at least one processor 404 for processing information. Computer system 400 also includes the main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) or other static storage device for storing static information and instructions for processor 404. The storage device 410, such as a magnetic disk or optical disk, is provided for storing information and instructions. The communication interface 418 may enable the computer system 400 to communicate with one or more networks through use of the network link 420 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A non-transitory computer-readable medium that stores instructions for facilitating sales transactions between multiple computers in communication over a network, the instructions being executable by one or more processors to perform operations that include:
(a) identifying a transaction, including an item that is offered for sale on an online medium, the item being associated with (i) a list price that is published to prospective buyers, and (ii) a minimum designated price that is undisclosed to users of the online medium;
(b) detecting one or more offers for the item from one or more bidders;
(c) when at least a first offer of the one or more offers is equal to or greater than the minimum designated price but less than the list price, perform one or more operations to designate the transaction as complete based on either the first offer or the highest offer; and
(d) when the first offer is less than the minimum designated price:
prompting the seller to reduce the minimum designated price; and
providing an interface for the seller to place an alias offer under an alias, including implementing an alias bidding rule in which the alias offer must be below the minimum designated price but can be higher than the first offer, the alias presenting the seller as another bidder on the online medium.

2. The computer-readable medium of claim 1, wherein instructions for detecting the one or more offers includes instructions for monitoring for any offer received during a designated period of time, and wherein the first offer is the highest offer received in the duration of time.

3. The computer-readable medium of claim 2, wherein the one or more offers are received and hidden from the users of the online medium during the duration of time.

4. The computer-readable medium of claim 1, wherein the computer-readable medium is implemented by a programmatic network resource that is external to the online medium.

5. The computer-readable medium of claim 1, wherein the computer-readable medium is implemented by the online medium.

6. The computer-readable medium of claim 1, wherein the minimum designated price is specified by the seller.

7. The computer-readable medium of claim 1, wherein the minimum designated price is programmatically determined.

8. The computer-readable medium of claim 1, wherein (a), (b), and at least one of (c) or (d) are implemented as an alternative process that is triggered by an event that follows publication of the transaction in the online medium.

9. The computer-readable medium of claim 8, wherein the event corresponds to a user initiating the alternative process after publishing the transaction in the online medium.

10. The computer-readable medium of claim 9, wherein the user is the seller of the item on the online medium.
